(19) United States
(12) Patent Application Publication
(10) Pub. No.: US 2009/0209378 A1
(43) Pub. Date: Aug. 20, 2009

(54) HYDRAULIC TENSIONER

(75) Inventor: Yuji Kurematsu, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/354,909

(22) Filed: Jan. 16, 2009

(30) Foreign Application Priority Data
Feb. 18, 2008 (JP) 2008-035574

(51) Int. Cl. F16H 7/08

(52) U.S. Cl. 474/110

(57) ABSTRACT

The hollow plunger of a hydraulic tensioner, slidably receives a sleeve that divides the high pressure oil chamber into two parts. The first part is formed by the plunger and a plunger-accommodating hole of the tensioner housing. The second part is formed by the plunger and the sleeve. Two springs, one being in the first part, and the other being in the second part, urge the plunger in the protruding direction. When the second part is filled with oil during ordinary engine operation, a negative pressure in the second part exerts a force opposing protruding movement of the plunger. Therefore, the springs can be made strong enough to prevent excessive chain vibration and noise during engine start-up when the parts of the high pressure oil chamber are not filled with oil, without causing the tensioner to exert excessive force on the chain during ordinary engine operation.

### CROSS-REFERENCE TO RELATED APPLICATION

This application claims priority on the basis of Japanese patent application 2008-035574, filed Feb. 18, 2008. The disclosure of Japanese application 2008-035574 is hereby incorporated by reference.

### FIELD OF THE INVENTION

The invention relates to a hydraulic tensioner for maintaining proper tension in an endless, flexible, traveling transmission medium such as a timing belt or a timing chain in a vehicle engine.

### BACKGROUND OF THE INVENTION

Hydraulic tensioners incorporating check valves have been widely used to maintain proper tension, and to suppress vibration, in a timing belts or timing chain used to transmit rotation between a crankshaft and one or more camshafts in a vehicle engine.

As shown in FIG. 7, a conventional hydraulic tensioner 500 is typically mounted on an engine adjacent the slack side of a timing chain C, which is driven by a crankshaft sprocket S1 and in driving relationship with camshaft sprockets S2. A plunger 520 protrudes slidably from a housing 510 and applies tension to the slack side of the timing chain C by pressing against the back of a pivoted lever L1 on which the chain slides. A fixed guide L2 is provided on the tension side of the timing chain C. The sprockets and chain move in the directions indicated by arrows.

As shown in FIG. 8, in the hydraulic tensioner 500, the plunger 520, which is hollow, fits slidably in a plunger-accommodating hole 511 formed in the housing 510. A high pressure oil chamber R is formed by the plunger 520 and a plunger-accommodating hole 511. The plunger is urged in the protruding direction by a plunger-biasing coil spring 530.

A check valve unit 540 is press-fit into the bottom portion of the plunger-accommodating hole 511. The check valve unit allows oil to flow from a source (not shown) of oil under pressure into the high pressure oil chamber R, but blocks reverse flow of oil.

The check valve unit 540 comprises a ball 541, a ball guide 542, which envelops the ball 541, a retainer 543, fixed to one end of the guide 542, and a ball seat 544, fixed to the opposite end of the guide 542. The ball can move toward and away from the seat through a distance limited by the retainer. When the ball guide is moved away from the seat, oil can flow through the check valve unit 540 into the high pressure oil chamber R. When the ball is in engagement with the seat, it blocks reverse flow of oil.

The tensioner also has a rack 522 on the plunger 520 and a pawl 560, pivoted to the housing 510 and biased into engagement with the rack 522 by a pawl-biasing spring 561. The rack and pawl serve as a ratchet mechanism, which limits retracting movement of the plunger to a distance corresponding to the backlash of the ratchet mechanism.

In operation of the tensioner, oil in the high pressure oil chamber R leaks through a slight clearance between the outer circumferential surface of the plunger 520 and the inner circumferential surface of the plunger-accommodating hole 511, and is discharged to the outside of the housing 510. Because of the viscosity of the oil, there is a resistance to flow through the clearance between the plunger and the plunger-accommodating hole. The resistance to flow enables the tensioner to exert a damping action, absorbing impact forces exerted on the plunger 520 and reducing vibration of the plunger 520. The force exerted on the plunger by the pressure of the oil supplied to the high pressure oil chamber R pressure oil is added to pressing force of the plunger-biasing spring 530. An example of a hydraulic tensioner having the above-described features is found in United States Patent Application Publication US2005/0227799.

In a conventional hydraulic tensioner, oil is supplied to the high pressure oil chamber by a pump driven by an engine. When the engine is stopped, the supply of oil to the high pressure oil chamber is also stopped. Some of the oil left in the chamber leaks through the clearance between the plunger and the inner circumferential surface of the plunger-accommodating hole and is discharged and replaced by air. When the engine is re-started after having been stopped for a long time, a considerable amount of time is required for replenishment of the oil in the high pressure oil chamber of the tensioner, and the damping action of the tensioner is therefore delayed. Thus the conventional hydraulic tensioner has different properties at the time of engine start-up and during ordinary engine operation.

More particularly, at the time of engine start-up, when oil in the high pressure oil chamber R depleted, the contribution of the viscous flow of oil through the leakage path to resistance to pressing-in of the plunger is substantially zero. The load on the plunger is resisted primarily by the plunger-biasing spring 530 both when the plunger is moving in the protruding direction and when the plunger is moving in the retracting direction. On engine-start-up, the pressing force and the damping action of the tensioner are at a lower level than during ordinary operation of the engine.

On the other hand, during ordinary operation of an engine, as the plunger 520 is pressed inward, the check valve 540 blocks flow of oil out of the high pressure oil chamber R as shown in FIG. 9. Thus, the pressure within the high pressure oil chamber R is increased as a result of resistance to flow of oil through the small clearance between the plunger 520 and the inner circumferential surface of the plunger-accommodating hole 511. The pressing force exerted by the plunger 520 is the result of the force exerted by the pressure of the oil added to the force exerted by the plunger-biasing spring 530. When the plunger 520 moves in the protruding direction, the check valve 540 is opened so that oil is supplied under pressure into the high pressure oil chamber R as shown in FIG. 10. Here, the pressing force exerted by the plunger 520 is the result of the force exerted by the pressure of the oil supply added to the force exerted by the plunger-biasing spring 530.

The above-described conditions are summarized in FIG. 11. On engine start-up, the pressing force T01, exerted by the plunger as it is pressed inward, and the pressing force T02, exerted by the plunger as it protrudes, are both equal to the force Ts, exerted by the plunger-biasing spring. That is T01=T02=Ts

During ordinary operation of the engine, the pressing force T11 exerted during pressing-in of the plunger is the sum of the spring force Ts and the pressing force Tp1 exerted by the oil compressed in the high pressure oil chamber. That is, T11=Ts+Tp1.

During ordinary operation of the engine, the pressing force T12, exerted during protruding movement of the plunger is the sum of the spring force Ts and the force Tp2 exerted by the pressure of the oil supply. That is, T12=Ts+Tp2.

When the forces T11 and T12, exerted during ordinary engine operation, are adjusted to optimum levels, the forces T01 and T02, exerted during engine start-up are too low. Consequently, the tension-applying force is inadequate to prevent generation of vibration and noise.

Furthermore, if the pressing force Ts of the plunger-biasing spring is increased in order to increase forces T01 and T02 and thereby avoid generation of vibration and noise, the pressing forces T11 and T12 of the plunger become excessive. In particularly, when the pressing force T12, exerted during protrusion of the plunger, becomes excessive, excessive tension is applied to the timing chain, resulting in skidding contact sounds, increased wear, and an increased risk of breakage of the timing chain and the timing transmission sprockets.

Accordingly, objects of the invention is to solve the above-described problems and to provide a hydraulic tensioner in which vibration and noise, occurring on engine start-up before the tensioner becomes filled with oil, are reduced, and in which an appropriate pressing force is maintained during ordinary operation of the engine, when the tensioner is filled with oil.

### SUMMARY OF THE INVENTION

The hydraulic tensioner according to the invention comprises a housing having a plunger-accommodating hole, and a plunger slidably protruding from the plunger-accommodating hole through the opening, and, with the hole, defining a high pressure oil chamber. A plunger-biasing spring, disposed within the high pressure oil chamber, biases the plunger in the protruding direction. A check valve unit incorporated into the bottom of the plunger-accommodating hole allows oil to flow into the high pressure oil chamber and blocks flow of oil out of the high pressure oil chamber. An inner sleeve-accommodating hole is formed in the plunger. The inner sleeve-accommodating hole has a sleeve opening facing the bottom of the high pressure oil chamber. An inner sleeve extends slidably into the inner sleeve-accommodating hole and divides the high pressure oil chamber into two parts. An inner sleeve-biasing spring is engaged with the end of the inner sleeve remote from the end of the inner sleeve-accommodating hole, and urges the sleeve into abutment with the check valve unit.

During ordinary operation of the engine, the part of the high pressure oil chamber within the inner sleeve-accommodating hole reaches a negative pressure during protrusion of the plunger. The negative pressure opposes the force exerted on the plunger by the inner sleeve biasing spring. Thus, the pressing force exerted by the plunger does not become excessive during ordinary operation of the engine, and an appropriate pressing force can be maintained.

Preferably, the shape of the front end of the inner sleeve forms a clearance for the flow of oil through the check valve unit into the high pressure oil chamber. As a result the rate of flow of oil into the hydraulic tensioner can be the same as the rate of flow of oil into a conventional hydraulic tensioner having no inner sleeve, and the same damping performance can be exhibited during ordinary engine operation.

### BRIEF DESCRIPTION OF THE DRAWINGS

FIG. 1 is a cross-sectional view of a hydraulic tensioner according to the invention.

FIG. 2 is a cross-sectional view illustrating the pressing-in of the plunger on starting the tensioner;

FIG. 3 is a cross-sectional view illustrating the protrusion of the plunger on starting the tensioner;

FIG. 4 is a cross-sectional view illustrating the usual operation of the tensioner;

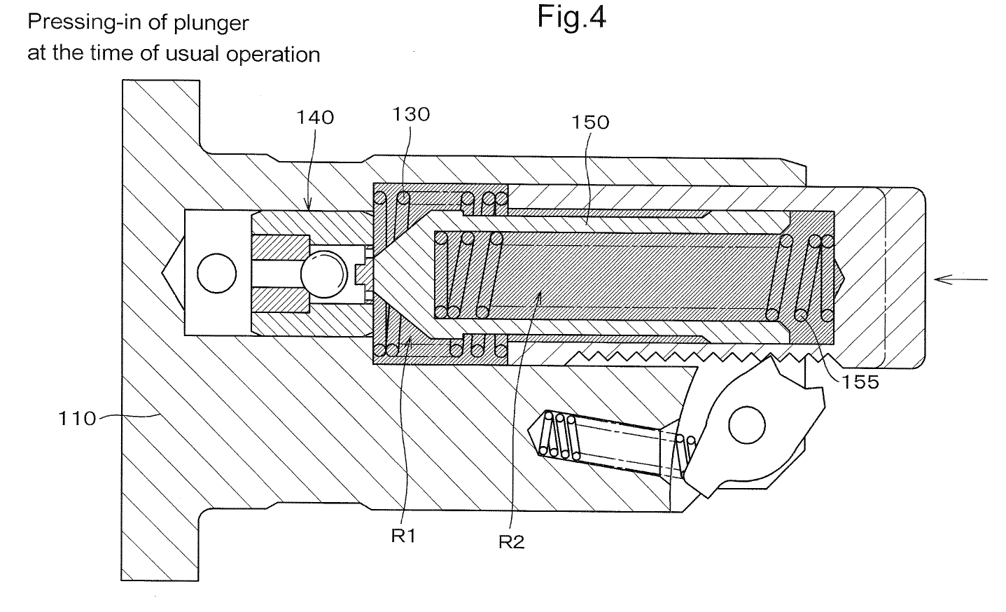

FIG. 5 is a cross-sectional view illustrating protrusion of the plunger during the usual operation of the tensioner;

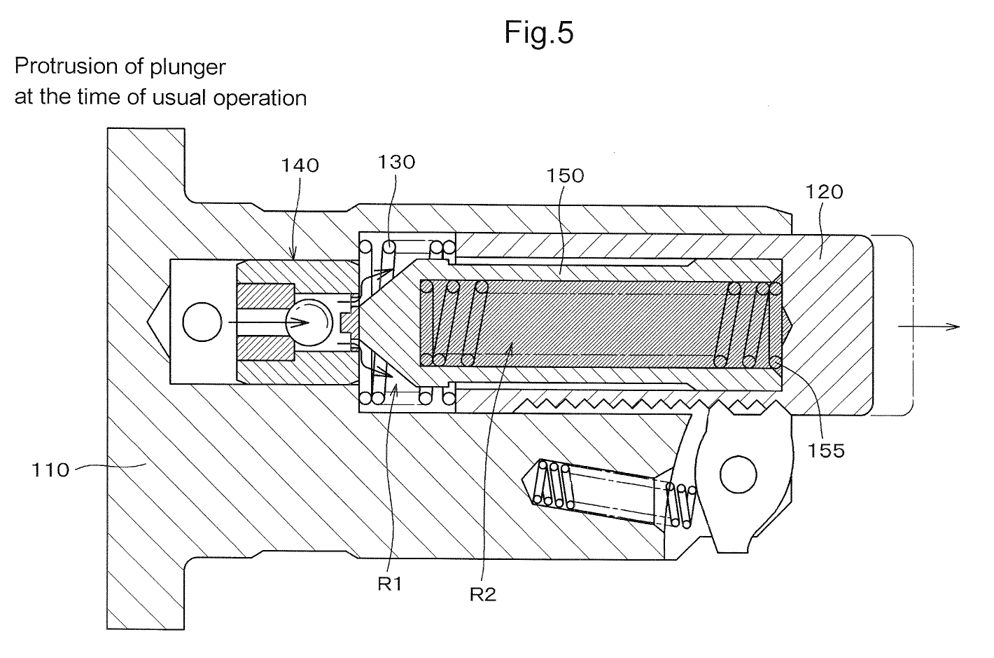

FIG. 6 is a table illustrating various conditions affecting the pressing force exerted by the plunger of the tensioner;

FIG. 7 is a schematic elevational view of the timing system of a conventional vehicle engine;

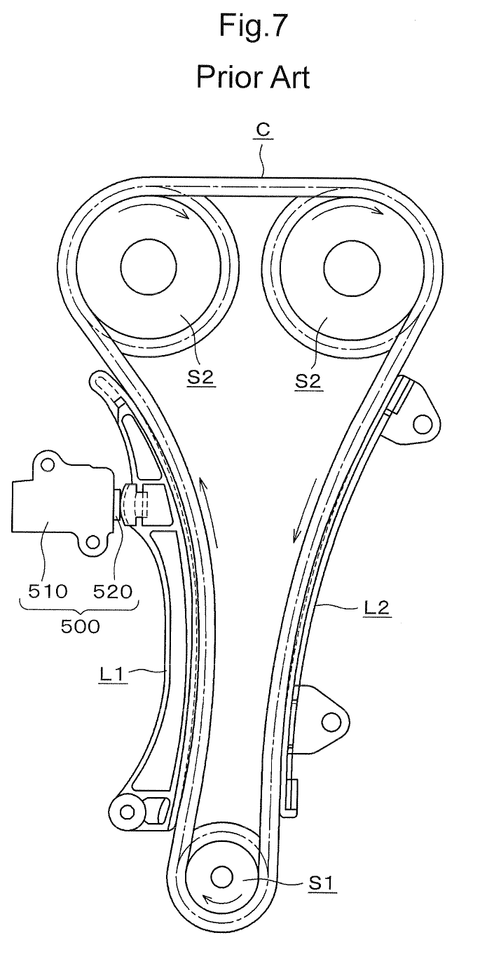

FIG. 8 is a cross-sectional view of a conventional hydraulic tensioner;

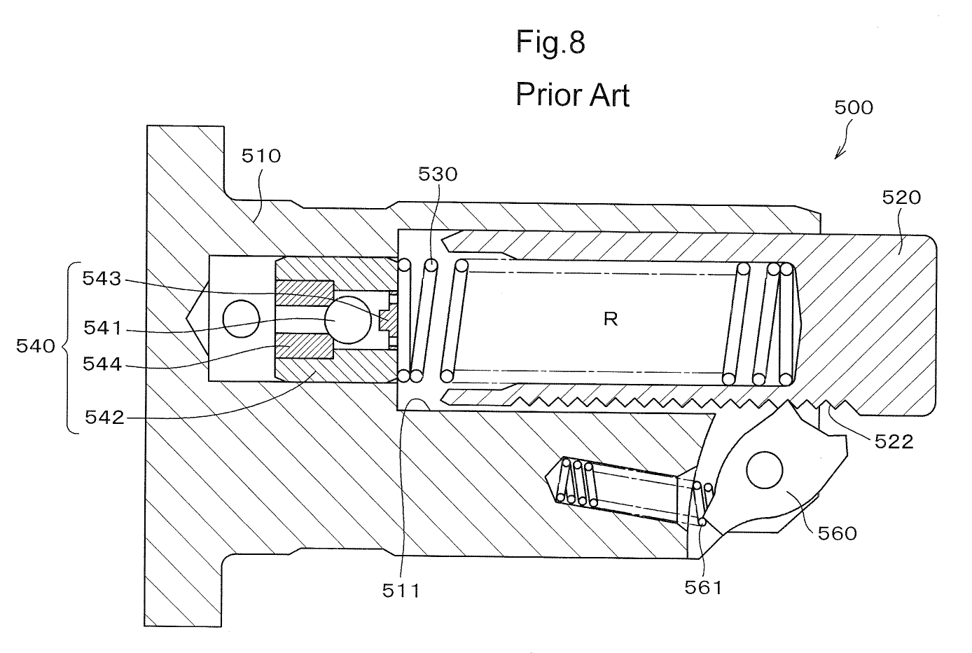

FIG. 9 is a cross-sectional view illustrating the pressing-in of the plunger on starting the conventional tensioner;

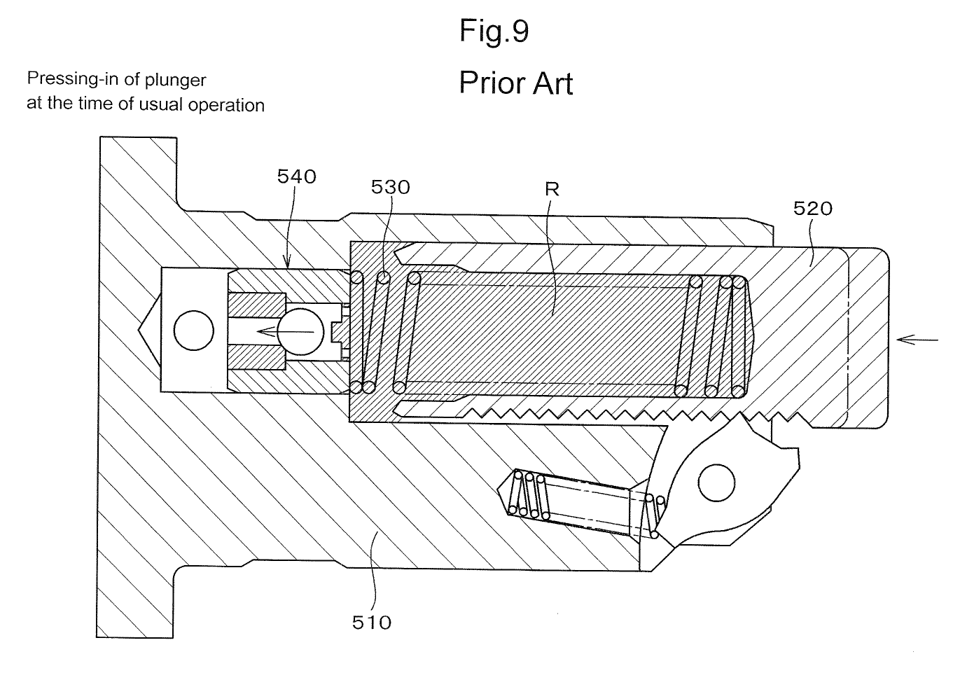

FIG. 10 is a cross-sectional view illustrating the protrusion of the plunger on starting the conventional tensioner; and

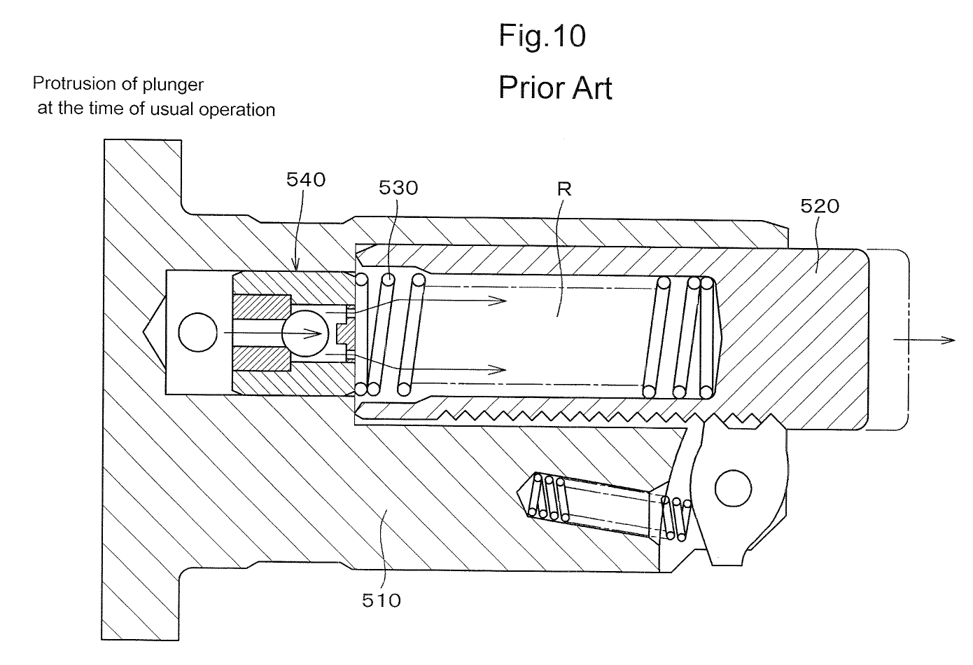

FIG. 11 is a table illustrating various conditions affecting the pressing force exerted by the plunger of the conventional tensioner.

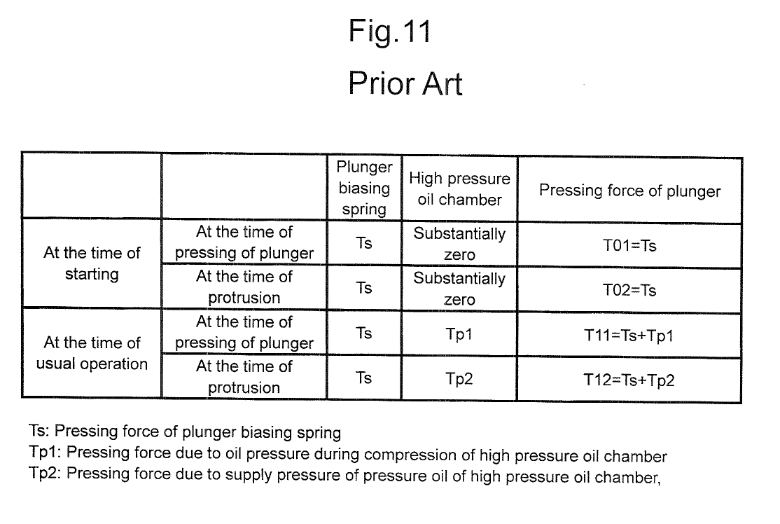

### DETAILED DESCRIPTION OF THE PREFERRED EMBODIMENT

Briefly, in the hydraulic tensioner according to the invention, an inner sleeve divides the high pressure oil chamber into two parts. During protrusion of the plunger, a negative pressure within a part of the high pressure oil chamber opposes the spring force exerted on the plunger and prevents the pressing force exerted by the plunger from becoming excessive during ordinary operation of the engine.

The tensioner can utilize any of various types of check valves, and the inner sleeve can be composed of any of various materials, including, for example, a metal such as iron, or a resin or the like.

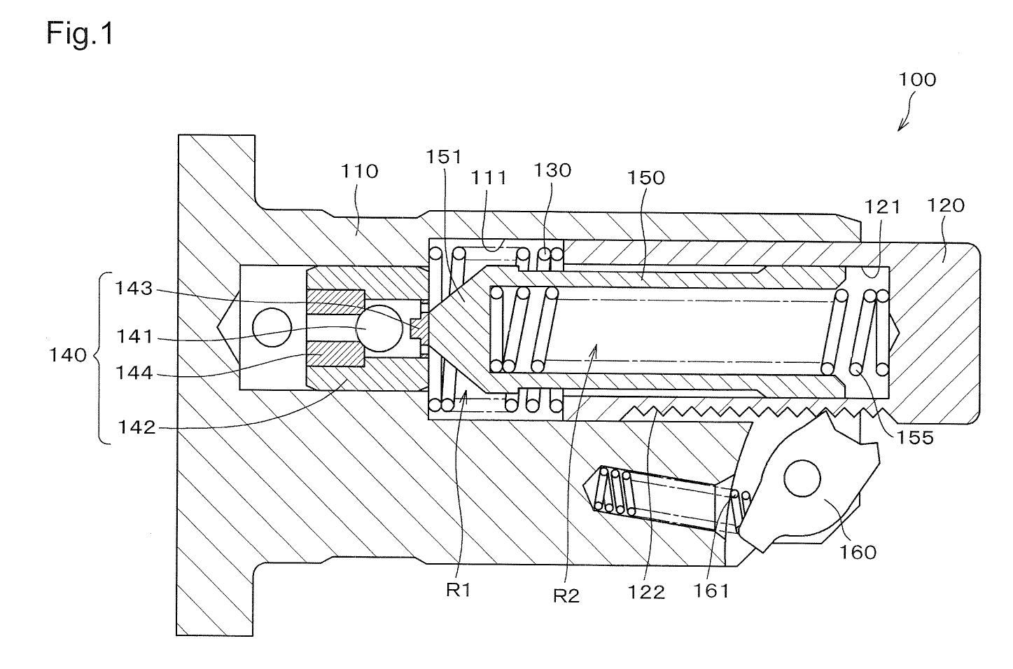

As shown in FIG. 1, in a hydraulic tensioner 100, a hollow, cylindrical plunger 120 is slidable in a plunger-accommodating hole 111 formed in a housing 110, and a hollow inner sleeve 150 fits slidably in an inner sleeve accommodating hole 121 formed in the plunger. The hollow plunger has a blind hole having an opening facing toward the bottom of the plunger-accommodating hole, and the hollow sleeve has a blind hole having an opening facing in the opposite direction.

The inner sleeve 150 separates the high pressure oil chamber into two parts R1 and R2. Part R1 is defined by the plunger-accommodating hole 111, the plunger 120, and the exterior of the sleeve 150. A restricted oil leakage path is provided between a cylindrical external part of the plunger and the inner wall of the plunger-accommodating hole. Part R2 is defined by the interior of the plunger 120 and the interior of the inner sleeve 150. A restricted oil leakage path is provided between a cylindrical part of the exterior of the sleeve and the cylindrical interior wall of the plunger. A coiled plunger-biasing spring 130, accommodated in the first part R1, surrounds the sleeve 150 and presses against the part of the plunger surround the opening of the hole formed in the plunger, biasing the plunger 120 in the protruding direction. In the second part R2, which is formed by the inner sleeve 150 and the inner sleeve-accommodating hole 121, a coiled inner sleeve biasing spring 155 urges the inner sleeve 150 out of the plunger and toward the bottom of the plunger-accommodating hole. At the same time, spring 155 augments the force exerted on the plunger by spring 130. Consequently, both springs 130 and 155 contribute additively to the total force urging the plunger 120 in the protruding direction.

A check valve unit 140, is incorporated into a bottom portion of the plunger-accommodating hole 111 for allowing oil to flow under pressure from a source (not shown) into part R1 of the high pressure oil chamber, while blocking reverse flow of oil.

The check valve unit 140 comprises a check ball 141, a ball seat 144, a ball guide 142, which envelops the ball while allowing the ball to move freely toward and away from the ball seat, and a retainer 143, fixed to the ball guide 142. The retainer holds check ball in the ball guide 142, while allowing the ball to move toward and away from the seat 144 through a limited distance.

A rack 122 on the plunger 120 is engaged by a pawl 160, which is pivoted on the housing 110 and biased by a spring 161 into engagement the rack 122 to allow the plunger to move in the protruding direction while limiting retraction of the plunger to an amount corresponding to the backlash of the ratchet mechanism. The ratchet mechanism is, of course, optional.

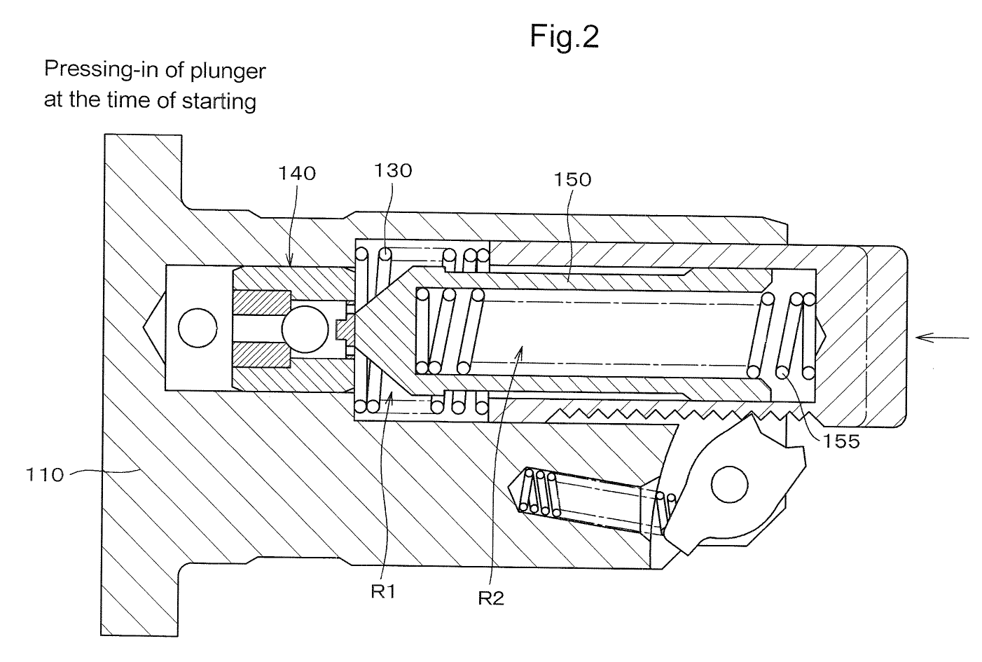

The protruding end 151 of the inner sleeve 150 abuts the ball guide 142, limiting movement of the inner sleeve relative to the housing 110. The protruding end is tapered and in the shape of a truncated cone, providing a clearance for the flow of oil through the check valve into chamber R1. When the plunger 120 is pressed inward at the time of engine start-up, as shown in FIG. 2, both chambers R1 and R2 are in an oil-depleted condition. Resistance to flow of oil does not materially contribute to the pressing force exerted by the plunger, and therefore, the pressing force T01 exerted by the plunger 120 is the sum of the force Ts1 exerted by the plunger-biasing spring 130 and the force Ts2 exerted by the inner sleeve biasing spring 155. Thus, T01=Ts1+Ts2.

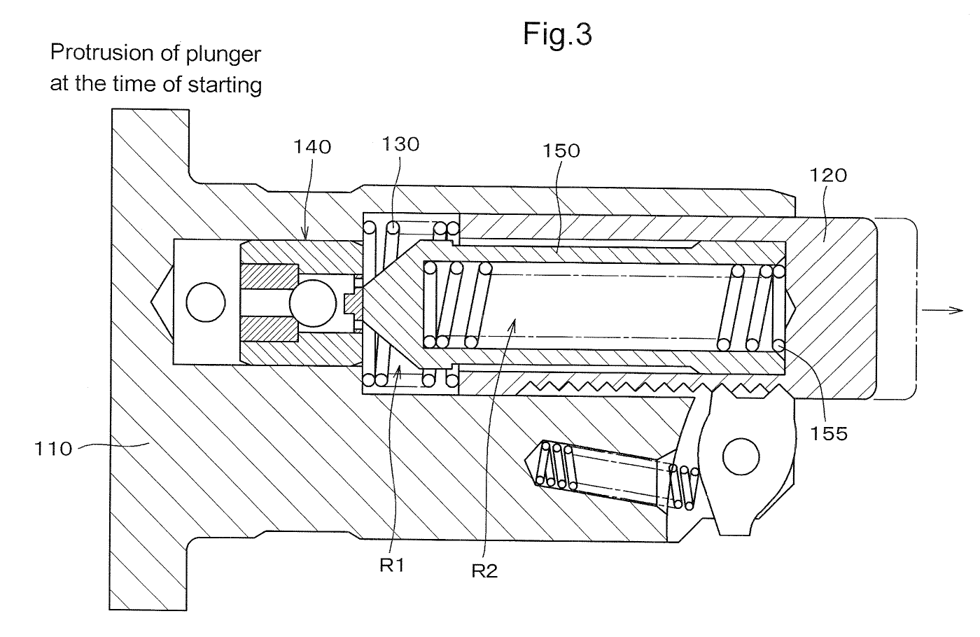

When the plunger 120 moves in the protruding direction at the time of engine start-up, as shown in FIG. 3, both chambers R1 and R2 are still in an oil-depleted condition. Here also, resistance to flow of oil does not contribute materially to the pressing force exerted by the plunger. The pressing force T02 exerted by the plunger 120 is also the sum of the force Ts1 exerted by the plunger-biasing spring 130 and the force Ts2 exerted by the inner sleeve biasing spring 155. Thus, T02=Ts1+Ts2.

During ordinary engine operation, when the parts R1 and R2 of the high pressure oil chamber are completely filled with oil, when the plunger 120 is pressed inward, the pressing force Ts1 of the plunger-biasing spring 130 and the pressing force Ts2 of the inner sleeve biasing spring 155 act additively as components of the total pressing force T11 exerted by the plunger. Additionally, the oil pressure in chamber R2 is increased because of resistance to flow of the viscous oil through the small clearance between an outer circumferential surface of the inner sleeve 150 and an inner circumferential surface of the inner sleeve accommodating hole 121. Reverse flow of the oil is blocked by the check valve unit 140. Thus, the pressure in part R1 of the high pressure oil chamber is also increased as a result of resistance to flow of oil through the small clearance between the outer circumferential surface of the plunger 120 and the inner circumferential surface of the plunger-accommodating hole 111. Consequently, the pressing force Tp11 due to pressure in part R1 of the oil chamber and the pressing force Tp21 due to pressure in part R2 of the oil chamber R2 act additively. The total pressing force T11 exerted by the plunger is given by T11=Ts1+Ts2+Tp11+Tp21.

When the plunger 120 is moved in the protruding direction during ordinary operation of the engine, the pressing force Ts1 of the plunger-biasing spring 130 and the pressing force Ts2 of the inner sleeve biasing spring 155 act additively, as components of the total force T12 exerted by the plunger 120. Additionally, since the check valve 140 opens as the plunger moves in the protruding direction, oil flows into part R1 of the high pressure oil chamber, and the pressure therein corresponds to the oil supply pressure, resulting in a pressing force component Tp12, which is added the spring force components Ts1 and Ts2.

On the other hand, because of the viscosity of the oil, there is a resistance to flow of oil into part R2 of the high pressure oil chamber through the small clearance between the outer circumferential surface of the inner sleeve 150 and the inner circumferential surface of the hole 121 in the plunger as the plunger moves in the protruding direction and the volume of part R2 expands. The result is a negative pressure within part R2 which resists protruding movement of the plunger. The negative pressure results in a force Tp22, acting in a direction urging the plunger into the plunger-accommodating hole 111. This force Tp22 is subtracted from the sum of the spring forces and the force due to the oil supply pressure, with the result that the force T12 exerted by the plunger is given by T12=Ts1+Ts2+Tp12−Tp22

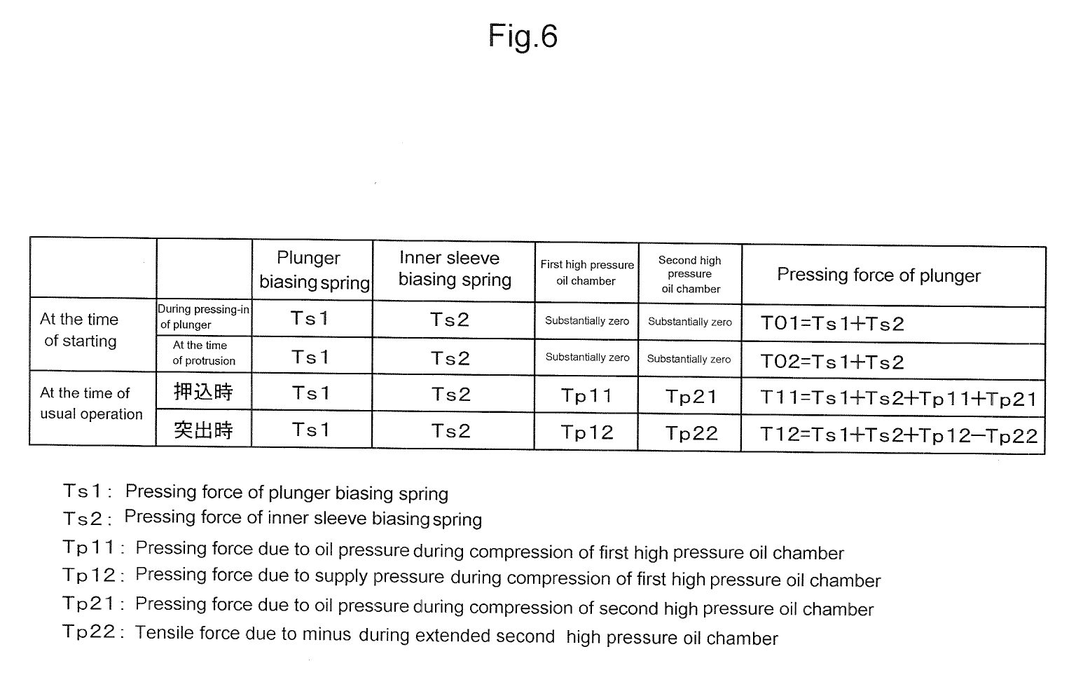

The forces exerted by the plunger 120 under the four conditions described above are summarized in the table in FIG. 6.

During engine start-up, when parts R1 and R2 of the high pressure oil chamber are not filled with oil, the force exerted by the plunger is given by T01=T02=Ts1+Ts2.

During ordinary engine operation, with parts R1 and R2 filled with oil, when the plunger is pressed inward, the force T11 exerted by the plunger is given by T11=Ts1+Ts2+Tp11+Tp21.

During ordinary engine operation, with parts R1 and R2 filled with oil, when the plunger moves in the protruding direction, the force T12 exerted by the plunger is given by T12=Ts1+Ts2+Tp12−Tp22

Even if the spring forces Ts1 and Ts2 are set to a large value in order to avoid vibration and noise to a inadequate chain tension on engine start-up, the pressing force T12, exerted by the plunger during ordinary engine operation, can be maintained at an appropriate level due to the fact that the second part R2 of the high pressure oil chamber is under a negative pressure as the plunger moves in the protruding direction. Therefore, the tensioner does not apply excessive tension to the chain, sliding contact sounds and wear are avoided, and the risk of breakage of the chain and sprockets is reduced.

Furthermore, when the pressing force Ts1 of the plunger-biasing spring 130, the pressing force Ts2 of the inner sleeve biasing spring 150 and the resistance to flow of oil through the clearance between inner sleeve 150 and the hole 121 are appropriately selected, the pressing forces T11 and T12 exerted by the plunger 120 during ordinary engine operation can be set to optimum values.

Therefore, the tensioner according to the invention reduces noise and vibration during engine start-up, and also prevents the tensioner from exerting excessive pressing force on the chain during ordinary engine operation.

I claim:

1. A hydraulic tensioner comprising:
a housing having a plunger-accommodating hole formed therein, said hole having an opening and a bottom spaced from the opening;
a plunger slidably protruding from the plunger-accommodating hole through said opening, and, with said hole, defining a high pressure oil chamber;
a plunger-biasing spring disposed within the high pressure oil chamber, said spring biasing the plunger in a protruding direction; and
a check valve unit incorporated into the bottom of the plunger-accommodating hole for allowing oil to flow into the high pressure oil chamber and blocking flow of oil out of the high pressure oil chamber;
an inner sleeve-accommodating hole formed in said plunger, the inner sleeve-accommodating hole having a sleeve opening facing the bottom of the high pressure oil chamber and an end remote from said sleeve opening;
an inner sleeve extending slidably into the inner sleeve-accommodating hole and dividing the high pressure oil chamber into two parts, said inner sleeve having an end remote from said end of the inner sleeve-accommodating hole; and
an inner sleeve-biasing spring engaged with said end of the inner sleeve-accommodating hole and urging the sleeve into abutment with said check valve unit.

2. A hydraulic tensioner according to claim 1, in which the inner sleeve has a front end, the shape of the front end of the inner sleeve forming a clearance for the flow of oil through the check valve unit into the high pressure oil chamber.
